(19) United States
(12) Patent Application Publication
(10) Pub. No.: US 2010/0082658 A1
(43) Pub. Date: Apr. 1, 2010

(54) SYSTEMS AND METHODS FOR SURFACING CONTEXTUALLY RELEVANT INFORMATION

(75) Inventors: Athellina Athsani, San Jose, CA (US); Lawrence Gordon Tesler, Portola Valley, CA (US); Elizabeth F. Churchill, San Francisco, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/242,441

(22) Filed: Sep. 30, 2008

(51) Int. Cl. G06F 17/30; G06F 7/10

(52) U.S. Cl. 707/767; 707/E17.014

(57) ABSTRACT

The present invention is directed towards systems and methods for providing contextually relevant suggestions and content in response to user queries. The method according to one embodiment of the present invention comprises receiving a request from a user and retrieving refinement data associated with the request. The method identifies one or more contextually relevant refinement items on the basis of the retrieved refinement data and provides the refinement data and a plurality of results associated with the request.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention described herein generally relate to providing contextually relevant suggestions and content in response to user queries. More specifically, embodiments of the present invention are directed towards systems, methods and computer program products for returning one or more contextually relevant suggestions on the basis of query terms and contextual data.

### BACKGROUND OF THE INVENTION

Since the widespread adoption of Internet, disparate types of search engines (general knowledge search engines, domain specific search engines, mapping applications with various search functionalities, etc.) have emerged as a lucrative source of revenue. Numerous attempts have been made to maximize the efficiency of search engines and, subsequently, to maximize the revenue generated advertising on search result pages. Indeed, techniques have been devised to increase the relevancy of search results returned by a search engine.

While search engine providers have made great strides in optimizing search algorithms, commensurate progress has not been made with regards to the localization and contextualization of search results. As the Internet achieves greater penetration in local markets across the globe, the contextual relevancy of search results is becoming increasingly important. Currently, search engines provide only elementary contextual relevance features, if providing any at all. A common technique used by search engines allows a user to re-execute his or her query on a subset of documents marked as specific to a given locale. For example, users can enter a query in a global search engine interface and may choose to refine searches to specific countries (e.g., pages designated as French or German) and vice-versa. Other techniques involve providing a user with the option to translate a given search result to a chosen language.

The current state of the art provides only rudimentary contextual relevance support for search results. Thus, there exists a need in the current state of the art for systems, methods and computer program products for generating contextually relevant refinement data on the basis of an original query and contextual data associated with the query.

### SUMMARY OF THE INVENTION

The present invention is directed towards systems and methods for providing contextually relevant suggestions and content in response to user queries. The method of the present invention comprises receiving a request from a user and retrieving refinement data associated with the request. The method identifies one or more contextually-relevant refinement items on the basis of the retrieved refinement data and provides the refinement data, which includes one or more contextually-relevant refinement items and a plurality of content and recommendation results associated with the request.

In one embodiment, retrieving refinement data comprises retrieving user profile data, which may comprise retrieving contextually-relevant data including, but not limited to, data such as geographical data, cultural affiliations, semantic affiliations, social network affiliations, etc. In a second embodiment, retrieving refinement data comprises retrieving geographical, temporal, social and event-related data at run-time wherein retrieving geographical data at run-time comprises determining a location based upon but not limited to an IP address or GPS-data associated with the request. Retrieving temporal data at run-time comprises determining temporal constructs such as dates, season, frequency and time which are related to the request embodied in context, retrieving social data at run-time comprises determining persons, devices or proxies who are related to the request embodied in context and lastly event/topical data retrieved at run-time comprises of objects or topics, concrete or abstract, which relate to the request embodied in the context. In a third embodiment, retrieving refinement data comprises retrieving request history data associated with the user. In a fourth embodiment, retrieving refinement data comprises retrieving visitation history data associated with the user including, but not limited to, web sites or web pages the user has visited, as well as what the user has done on pages the he or she has visited.

Retrieving refinement data may further comprise retrieving aggregate data from a plurality of requests wherein retrieving aggregate data from a plurality of requests comprises aggregating data across global requests, e.g., search requests from a plurality of users, which may comprise all users of a query system such as a search engine. In an alternative embodiment, retrieving refinement data comprises retrieving contextually relevant refinement data associated with the request. Finally, retrieving refinement data may comprise retrieving contextually relevant refinement data associated with the request comprising substituting terms within the request with contextually relevant terms.

The system of the present invention comprises a plurality of client devices operative to transmit requests across a network and a plurality of databases operative to store refinement data associated with the request. In a first embodiment, the plurality of databases comprises at least one user data store comprising user profile data wherein user profile data comprises contextual data including, but not limited to, geographical data associated with a client device, cultural affiliations, diasporic affiliations, social networking affiliations, etc. In a second embodiment, the plurality of databases comprises at least one search history database operative to store request history data associated with a client device or proxy. Furthermore, the plurality of databases may comprise at least one aggregate user data store that may be operative to maintain user visitation data.

In a third embodiment, the plurality of databases comprises at least one aggregate user data store operative to aggregate data (e.g., behavior tracking) from a plurality of requests and clickthroughs, wherein aggregate search data comprises aggregate data across global requests. In a last embodiment, the plurality of databases comprises at least one contextually relevant refinement data store operative to maintain contextually relevant refinement data associated with the request wherein contextually relevant refinement data comprises association between request terms and contextually relevant counterparts.

The system further comprises a search engine operative to retrieve the refinement data, identify one or more contextually relevant refinement items on the basis of the retrieved refinement data and provide the refinement data (which may include one or more contextually relevant refinement items) and a plurality of search results associated with the request.

In one embodiment, retrieving refinement data comprises retrieving user profile data, which may comprise retrieving contextually-relevant data including, but not limited to, data such as geographical data, cultural affiliations, semantic affiliations, social network affiliations, etc. In a second embodiment, retrieving refinement data comprises retrieving geographical, temporal, social and event-related data at run-time wherein retrieving geographical data at run-time comprises determining a location based upon but not limited to an IP address or GPS-data associated with the request. Retrieving temporal data at run-time comprises determining temporal constructs such as dates, season, frequency and time which are related to the request embodied in context, retrieving social data at run-time comprises determining persons, devices or proxies who are related to the request embodied in context and lastly event/topical data retrieved at run-time comprises of objects or topics, concrete or abstract that relate to the request embodied in the context. In a third embodiment, retrieving refinement data comprises retrieving request history data associated with the user. In a fourth embodiment, retrieving refinement data comprises retrieving visitation history data associated with the user including, but not limited to, web sites or web pages the user has visited, as well as what the user has done on pages the he or she has visited.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for providing contextually relevant search suggestions and content in response to user search queries according to one embodiment of the present invention;

FIG. 2 presents a flow diagram illustrating a method for determining contextually relevant content from a user query according to one embodiment of the present invention; and

FIG. 3 presents a flow diagram illustrating a method for processing a contextually relevant search refinement request according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

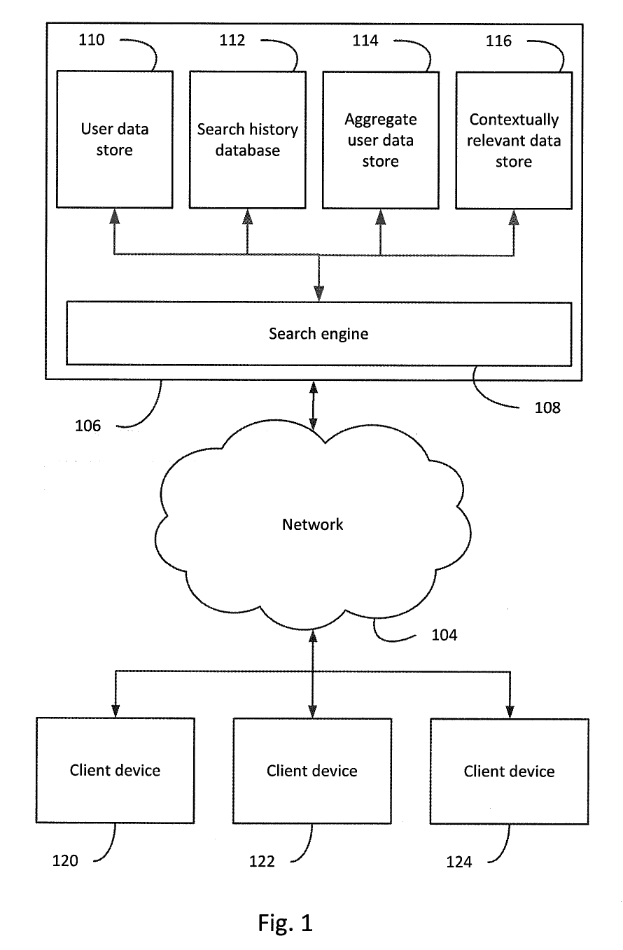

FIG. 1 presents a block diagram depicting a system for providing contextually relevant recommendations and content in response to user queries according to one embodiment of the present invention. According to the embodiment that FIG. 1 illustrates, a plurality of client devices 120, 122, 124 are connected to a network 104. A search provider 106 comprising a search engine 108, user data store 110, search history data store 112, aggregate data store 114 and contextually relevant data store 116. The search provider 106 is in communication with a network 104 operative to facilitate data transfers between the search provider 106 and client devices 120, 122, 124.

Client devices 120, 122, 124 comprise general purpose computing (mobile or otherwise) devices having a central processing unit, memory unit, permanent storage, optical drive(s), universal serial bus port(s), audio/video output devices, network interfaces, etc. Client devices 120, 122, 124 are operative to communicate via network 104 which may comprise a local or wide area network such as the Internet. In the present embodiment, client devices 120, 122, 124 transmit requests to search provider 106 via the HTTP protocol, WAP protocol or similar protocol.

Search provider 106 comprises a search engine 108 operative to handle incoming requests and manage outgoing transmissions of search results to a client device 120, 122, 124. Search engine 108 is operative to provide a plurality of search results for a given query. For example, if a user searches for the terms “pub”, “maida vale”, “food” and “list of pubs”, the search engine 108 is operative to retrieve links to a first plurality of documents matching the search terms. Search engine 108 may be operative to query a search index (not shown) for the requested terms and may return a plurality of links to content items that are potential matches for the query.

In addition to retrieving keyword based search results, the search engine 108 queries a plurality of databases 110, 112, 114 and 116 to retrieve additional contextually relevant refined recommendations or content, as is described in greater detail herein. It should be noted that search engine 108 may be operative to query one or more databases 110, 112, 114 and 116 or may be operative to query a subset of the databases 110, 112, 114 and 116 or a combination thereof (e.g., query only database 110 and 114). A first database that the search engine 108 may query is the user data store 110. User data store 110 comprises data related to a specific user requesting the search results. For example, user data store 110 may contain profile data related to the user such as geographical data, interests, cultural/diasphoric/social networking affiliations or any other user profile metrics known to those of skill in the art.

Alternatively, or in conjunction with the foregoing, search engine 108 may be operative to determine user data in response to receipt of a query. For example, the search engine 108 may determine the Internet protocol (“IP”) address of the request and may extract a location based on the user's IP address. Search engine 108 may utilize the user data to provide one or more refinement options for the user's request. Continuing with the above example, the search engine may determine that a user's request for “maida vale” corresponds to the West London neighborhood as opposed to various other locations having the name “maida vale” on the basis of geographical data indicating the user is located in London.

According to one embodiment, search engine 108 is additionally operative to query search history database 112. Search history database may comprise a plurality of past searches occurring within a temporal window with the current query. In one embodiment, search history comprises the requesting user, client device or proxy's search history. In an alternative embodiment, search history comprises global search history of search queries for users of the search engine 108. Continuing the previous example, in response to receiving a query containing the terms “pub” and “food”, the search engine 108 may determine, through data stored within search history database 112, that a user has recently searched for traditional English cuisine on the basis of a user's queries for “pork pie” or “toad in the hole.” In this example, the search engine 108 may provide a plurality of refinement suggestions narrowing the user's search to those pubs in Maida Vale that serve traditional English cuisine, as opposed to various other cuisines.

According to another embodiment, search engine 108 is further coupled to aggregate user data store 114. Aggregate user data store 114 contains aggregated data corresponding to global search patterns or history associated with a user, client device or proxy. In one embodiment, aggregate user data store stores global queries associated with keywords. Continuing the previous example, aggregate user data store 114 may store data indicating that a global trend is present for queries containing the terms “maida vale” and “pub.” For example, a new pub may have recently opened in the Maida Vale neighborhood and may have caused a spike in user searches for the exemplary terms. Statistical data may indicate that a majority of users entering similar search terms have been interested in a particular pub. Search engine 108, upon receipt of this information, may provide one or more refinement requests to illustrate this global trend.

In another embodiment, through data gathered from the user profile data, the system determines that the user is affiliated with a pub gastronomic group. The system may provide a higher weighting to search results pertaining to food, pubs and restaurants associated with the query term ‘maida vale’ and return these as most relevant results. The system may use combinations of data such as data from the aggregate global user search patterns, the first user historical search patterns, the first user social affiliation, etc. to determine the most contextually-relevant content.

As can be seen from the above examples, search engine 108 may be operative to combine data from various databases 110, 112, 114 and 116 to generate refinement requests. Combining the above examples, search engine 108 first determines the appropriate location via user data store 110 or run-time analysis and utilizes this location data to determine current search trends for the location when querying aggregate user data store 114.

Search engine 108 may be further coupled to contextually relevant data store 116, which may be operative to store translations of search terms into contextually relevant forms. Expanding upon the previous examples, a user may enter a request comprising the terms “soccer in maida vale.” In response to this request, search engine 108 may query the user data store 110 to determine that “maida vale” corresponds to the West London neighborhood. Subsequently, the search engine 108 may query a contextually relevant data store to determine if contextually relevant refinement data exists for the query. As the search engine 108 has determined the location to be within England, the contextually relevant refinement data may indicate that in England the term “soccer” should be replaced by the term “football” to maximize the amount of relevant search results through utilization of the local dialect. In response to querying databases 110, 112, 114 and 116, the search engine 108 provides a plurality of contextually relevant refinement links, as is described in greater detail below.

As previously discussed with respect to search engine 108, the search engine 108 may provide a plurality of contextually relevant refinement items for a given query. In one embodiment, search engine 108 provides contextually relevant refinement items in the form of hyperlinks alongside search results for an original query, the hyperlink corresponding to contextually relevant requests. Search engine 108 may be operative to receive the contextually relevant requests and retrieve a second plurality of search results in response. In an alternative embodiment, search engine 108 may provide a plurality of refined search results in addition to the original search results. In addition to providing a plurality of search results, search engine 108 may further be operative to transmit program code operative to execute on a client device 120, 122 and 124 and monitor a user's interaction with the search results. In one embodiment, monitoring user interactions comprises storing click through data associated with a given search result.

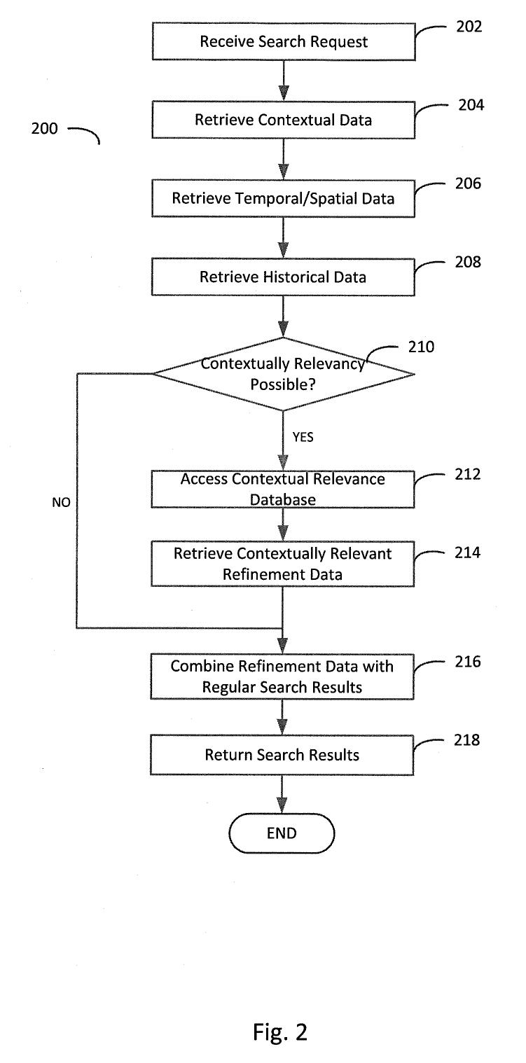

FIG. 2 presents a flow diagram illustrating a method for determining contextually relevant content from a query according to one embodiment of the present invention. As illustrated, the method 200 receives a request from a client device, step 202. A request according to one embodiment comprises a query for content. In one embodiment, the method 200 receives a request via an HTML form allowing a user to input a query. A query may comprise various alphanumeric characters arranged in a human-readable form, e.g., one or more search terms.

The method 200 according to the present embodiment retrieves contextual data, step 204. Contextual data includes any data relevant to the request including, but not limited to, a user's profile, a user's most recent queries, a user's affiliation with a query or query result, relevant current events associated with a query, or the like. Additionally, the method 200 retrieves temporal or spatial data and aggregate data, steps 206 and 208, respectively. Temporal or spatial data comprises data relevant to the disposition of the client device submitting the request. For example, temporal data may comprise the date and or time the method 200 receives the request. Similarly, spatial data may comprise data related to the location of a client device (e.g., city/state, latitude/longitude pairs or an Internet protocol (“IP”) address).

A check is made to determine if contextual relevancy is possible, step 210. In the illustrated embodiment, the method 200 determines if contextual relevancy is possible by analyzing the request. For example, the method 200 may be operative to determine that a query for “soba LA hand made” may correspond to a query directed towards Los Angeles as determined in step 206. In this example, the method 200 may determine contextual relevance is possible on the basis of the spatial data.

If contextual relevancy is possible, the method 200 accesses a contextual relevance database, step 212. In another embodiment, the method 200 may determine contextually relevancy is possible on the basis of locosemantics data. Locosemantics data may refer to data that identifies local meanings built between members of a group that know each other well or meanings associated with a social sub-group. In one embodiment, the method identifies contextually relevant semantics of the query terms as part of the query refinement data. The method may then perform queries in the contextually relevant semantics identified and translated to the original language when surfaced to the user. For example, assume that the system determines the query term ‘soba’ is a Japanese term. Furthermore, assume that the system makes the determination that the query relates to food on the basis of the term ‘soba’ being a Japanese food item. By translating the rest of the query phrase into Japanese and tapping into the Japanese food vocabulary, the system includes locosemantics data such as ‘teuchi’ as part of the contextually relevant refinement data to surface contextually-relevant query recommendations and/or query results.

In one embodiment, accessing a contextual relevance database comprises querying a relational database for a given term and retrieving a contextually relevant refinement data corresponding to the given term. For example, the British expression “wrong end of the stick” may have a Spanish counterpart of “pull the radish by the roots.” Upon receiving a query containing the British version, the method 200 may determine that a user is attempting to identify the Spanish equivalent of the expression on the basis of retrieving the Spanish counterpart from the contextual relevance database.

After accessing a contextual relevance database, the method 200 retrieves contextually relevant refinement data, step 214. In one embodiment, retrieving contextually relevant refinement data comprises executing ancillary web queries for retrieving relevant keywords associated with the contextually relevant refinement data. For example, the method 200 may execute a web query and may extract a plurality of keywords associated with the returned results. In an alternative embodiment, the method 200 may comprise accessing an internal search index containing keywords associated with content items, such as web documents.

The method 200 may combine the refinement data with regular request results to form one or more contextually relevant refinement items, step 216. In the present embodiment, refinement data includes refinement data retrieved in steps 204, 206 and 208 and contextually relevant refinement data retrieved in step 214. Combining refinement data with regular request results according to one embodiment comprises inserting recommendations into a standard search results page. In a first embodiment, inserting recommendations comprises placing suggested queries within a search results page. For example, the search results for the requested user query may be displayed and interspersed with contextually relevant search results retrieved by the method 200.

In an alternative embodiment, inserting refinement data comprises inserting recommended search results within the search results page. For example, a search result page may contain a plurality of search results associated with the requested query. The method 200 may additionally provide a plurality of suggested search queries that represent refined search queries. Upon selecting the refinement data, the method 200 may return a plurality of refined search results. In an alternative embodiment, the method 200 may return a combination of the aforementioned embodiments. For example, a subset of refined search results may be displayed along with a plurality of suggested refined search queries. In yet another embodiment, the system returns a series of query recommendations as the user types or otherwise enters the query in the search box.

The method 200 may return the search results, step 218. In one embodiment, returning search results comprises returning a search results page to a client device. A search results page may comprise search results directed towards the original request and a plurality of search recommendations generated in step 214. In an alternative embodiment, a search results page may comprise search results directed towards the original request and a plurality of recommended search results.

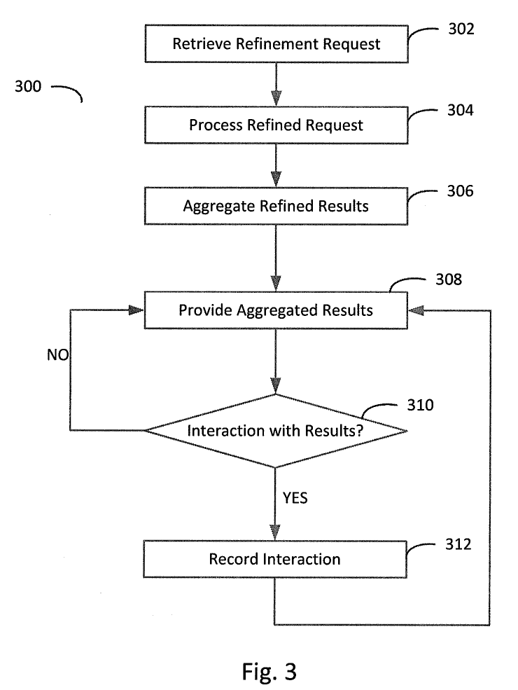

FIG. 3 presents a flow diagram illustrating a method for processing a refinement request according to one embodiment of the present invention. As illustrated, the method 300 receives a refinement request, step 302. In one embodiment, a refinement request comprises a request submitted to a search engine in response to providing a plurality of search recommendations. For example, in response to a user query a plurality of search recommendations may be presented in the form of hyperlinks wherein selection of the hyperlink results in a refinement request being received by the method 300. In one embodiment, the system determines that a term used in a query is associated with a disparate language from that used to formulate the original query. The system may use this data to either provide additional refinement data with contextual queries in the second language or to use the data to give more weight to contextually-relevant query recommendation/results based on refinement data from the second language. Still further, the system may utilize varying combinations of either result.

The method 300 processes the received refinement request, step 304. In one embodiment, processing a refinement request comprises executing an alternative web search. For example, if a refinement request comprises a plurality of alternative request terms, the method 300 may receive these alternative request terms and execute a query using the alternative request terms. In an alternative embodiment, processing a refinement request may comprise executing local, server-side applications. For example, a refinement request may comprise translating a plurality of text to a requested language.

The method 300 may aggregate the refined results, step 306. In one embodiment, aggregating results comprises combining a plurality of results from a plurality of sources (e.g., a federated search). For example, the method 300 may aggregate search results from a plurality of contextually relevant data sources such as foreign language search engines. A response to a user's original request may provide a plurality of refined requests comprising the same search in multiple languages. In response to receiving a refinement request, the method 300 may process the query in a different language and aggregate the retrieved results.

After aggregating the refined results, the method 300 provides the aggregated results, step 308. Providing refined search results may comprise displaying the aggregated results within a search results page rendered by a web browser. In one embodiment, a search results page contains the aggregated results as well as other search results page features known in the art such as form elements, advertisements and program code such as JavaScript, VBScript or the like.

The method 300 monitors the returned results for interaction with the results, step 310. If no interaction has taken place, the method 300 continues to display the results, step 308. If an interaction takes place, the method 300 is operative to record the interaction, step 312. In one embodiment, an interaction comprises an interaction with a returned result, such as the selection of a result via a mouse interaction. The method 300 may be operative to receive an indication that a user has selected a given result and may store the interaction data in an interaction database for data mining purposes such as trend analysis.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for providing contextually-relevant query suggestions and content in response to user queries, the method comprising:
receiving a request from a user;
retrieving refinement data associated with the request;
identifying one or more contextually-relevant refinement items on the basis of the retrieved refinement data; and
providing the refinement data including one or more contextually-relevant refinement items and a plurality of search results associated with the request.

2. The method of claim 1 wherein retrieving refinement data comprises retrieving user profile data.

3. The method of claim 2 wherein retrieving user profile data comprises retrieving contextually-relevant data such as but not limited to geographical, temporal, social, topical data, interests, semantic affiliation, cultural affiliation, social networking affiliation.

4. The method of claim 1 wherein retrieving refinement data comprises retrieving contextually-relevant data such as but not limited to geographical, temporal, social or topical-related at run-time.

5. The method of claim 1 wherein retrieving refinement data comprises retrieving search history data associated with the user.

6. The method of claim 1 wherein retrieving refinement data comprises retrieving web site visitation data associated with the user.

7. The method of claim 1 wherein retrieving refinement data comprises retrieving aggregate search data from a plurality of requests.

8. The method of claim 7 wherein retrieving aggregate search data from a plurality of requests comprises aggregating data across one or more global requests.

9. The method of claim 1 wherein retrieving refinement data comprises retrieving contextually-relevant refinement data associated with the request.

10. The method of claim 9 wherein retrieving contextually-relevant refinement data associated with the request comprises substituting terms within the request with contextually-relevant terms.

11. The method of claim 10 wherein substituting terms comprises substituting translated terms.

12. The method of claim 1 wherein providing the contextually-relevant refinement items and a plurality of search results associated with the request comprises presenting a search results page wherein contextually relevant refinement items are presented as one or more hyperlinks that link to contextually relevant requests.

13. The method of claim 1 wherein providing the contextually relevant refinement items and a plurality of search results associated with the request comprises presenting a search results page wherein contextually relevant refinement items are presented as one or more contextually relevant search results.

14. A system for providing contextually relevant search suggestions and content in response to user search queries, the system comprising:
a plurality of client devices operative to transmit requests across a network;
a plurality of databases operative to store refinement data associated with the request; and
a search engine operative to retrieve the refinement data, identify one or more contextually relevant refinement items on the basis of the retrieved refinement data and provide the refinement data including one or more contextually relevant refinement items and a plurality of search results associated with the request.

15. The system of claim 14 wherein the plurality of databases comprises at least one user data store comprising user profile data.

16. The system of claim 15 wherein user profile data comprises geographical, temporal, social & topical data associated with a user, client device or proxy.

17. The system of claim 14 wherein the search engine is further operative to determine geographical, temporal, social & topical data at run-time.

18. The system of claim 14 wherein the plurality of databases comprises at least one search history database operative to store search history data associated with a client device.

19. The system of claim 14 wherein the plurality of databases comprises at least one aggregate user data store operative to aggregate search data from a plurality of requests.

20. The system of claim 19 wherein aggregate search data comprises aggregate data across global requests.

21. The system of claim 14 wherein the plurality of databases comprises at least one contextually relevant data store operative to store contextually relevant refinement data associated with the request.

22. The system of claim 21 wherein contextually relevant refinement data comprises association between search terms and contextually relevant counterparts.

23. The system of claim 22 wherein associations between search terms and contextually relevant counterparts comprises translated versions of said search terms.

24. The system of claim 14 wherein providing the refinement data and a plurality of search results associated with the request comprises presenting a search results page wherein refinement data is presented as a plurality of hyperlinks indicating secondary refined requests.

25. The system of claim 14 wherein providing the refinement data and a plurality of search results associated with the request comprises presenting a search results page wherein refinement data is presented as one or more contextually relevant search results.

26. Computer readable media comprising program code that when executed by a programmable processor causes the programmable processor to execute a method for providing contextually relevant search suggestions and content in response to user search queries, the computer readable media comprising:
program code for receiving a request from a user;
program code for retrieving refinement data associated with the request;
program code for identifying one or more contextually relevant refinement items on the basis of the retrieved refinement data; and
program code for providing the refinement data including one or more contextually relevant refinement items and a plurality of search results associated with the request.

27. The computer readable media of claim 26 wherein program code for retrieving refinement data further comprises program code for retrieving user profile data.

28. The computer readable media of claim 27 wherein program code for retrieving user profile data further comprises program code for retrieving geographical, temporal, social & topical data.

29. The computer readable media of claim 26 wherein program code for retrieving refinement data further comprises program code for retrieving geographical, temporal, social & topical data at run-time.

30. The computer readable media of claim 26 wherein program code for retrieving refinement data further comprises program code for retrieving search history data associated with the user.

31. The computer readable media of claim 26 wherein program code for wherein retrieving refinement data further comprises program code for retrieving aggregate search data from a plurality of requests.

32. The computer readable media of claim 31 wherein program code for retrieving aggregate search data from a plurality of requests further comprises program code for aggregating data across a global requests.

33. The computer readable media of claim 26 wherein program code for retrieving refinement data further comprises program code for retrieving contextually relevant refinement data associated with the request.

34. The computer readable media of claim 33 wherein program code for retrieving contextually relevant refinement data associated with the request further comprises program code for comprising substituting terms within the request with contextually relevant terms.

35. The computer readable media of claim 34 wherein substituting terms comprises substituting translated terms.

36. The computer readable media of claim 26 wherein program code for providing the refinement data and a plurality of search results associated with the request further comprises program code for presenting a search results page wherein refinement data is presented as a plurality of hyperlinks indicating secondary refined requests.

37. The computer readable media of claim 26 wherein program code for providing the refinement data and a plurality of search results associated with the request further comprises program code for presenting a search results page wherein refinement data is presented as one or more contextually relevant search results.
